(19) United States
(12) Patent Application Publication
(10) Pub. No.: US 2024/0326138 A1
(43) Pub. Date: Oct. 3, 2024

(54) TOOL HOLDER DAMPER

(71) Applicant: GKN Aerospace Sweden AB, Trollhättan (SE)

(72) Inventors: Christer Zackrisson, Trollhättan (SE); James Gladh, Trollhättan (SE)

(21) Appl. No.: 18/576,409

(22) PCT Filed: Jul. 4, 2022
(86) PCT No.: PCT/EP2022/068469

§ 371 Date: Jan. 4, 2024

(30) Foreign Application Priority Data
Jul. 8, 2021 (GB) 2109869.4

(51) Int. Cl. B23C 5/00

(52) U.S. Cl. CPC B23C 5/003; B23C 2250/16

(57) ABSTRACT

A tool damper for a machine tool, such as a milling machine, is arranged around the tool stem of the machine or the tool holder of the machine and arranged to damper vibrations of the tool.

### CROSS-REFERENCE TO RELATED APPLICATIONS

This application is a national stage of, and claims priority to, Patent Cooperation Treaty Application No. PCT/EP2022/068469, filed on Jul. 4, 2022, which application claims priority to United Kingdom Application No. GB2109869.4, filed on Jul. 8, 2021, which applications are each hereby incorporated herein by reference in their entireties.

### BACKGROUND

Many high specification materials of the type used in the aerospace industry are metal alloys which are extremely hard and durable and which can withstand high temperatures and stresses. They are used in many applications where such materials are often required for high performance components. These components also often have small geometrical tolerances and so careful machining is required using specialist hardened cutting tools and materials.

Complex geometries can be created using multi-axis machining centers such as a 5-axis machining center. The high cutting speeds used in such machines can generate vibrations that are detrimental to the precise tolerances needed in some components.

The inventors have established that the performance of such machinery can be improved in terms of accuracy, reliability and cutting performance using an unconventional modification. This can dramatically increase productivity.

### SUMMARY

The present disclosure is concerned with a machining apparatus particularly, but not exclusively, for lathe or milling machine made components. One such machine is a milling machine in which a cutting bit or tip is held in a tool holder which is caused to rotate at high speed and to cut through material.

Viewed from a first aspect of this disclosure, there is provided a damping apparatus for a machine tool, the damping apparatus comprising an annular body with an inwardly facing surface, the inwardly facing surface arranged for coupling to an outer surface of a machine tool stem or an outer surface of a machine tool holder, wherein the annular body comprises an internal cavity, the cavity comprising a damping mass.

Thus, according to such an arrangement a machine tool damper is provided that may be conveniently fitted to any machine tool, including retrofitting to existing machine tools. The arrangement provides a dynamic moving body mass within the apparatus housing that responds to and substantially dampens vibrations generated by cutting actions of a cutting tool to which the damper is arranged. The annular body allows for convenient coupling to a candidate part of a machine tool stem or holder.

Advantageously the arrangement may be adapted to be coupled to any size of machine tool holder or stem and provides a simple and reliable construction that is highly resistant to the working environment of machine tooling. The arrangement may be conveniently manufactured as described herein and provides for highly reliable operation.

Furthermore the tooling damper may be optimised to the specific operating ranges of a cutting action though the selection of damper mass and elastomer.

The damping mass may be is coupled to and spaced from the inwardly facing surface of the internal cavity by one or more elastomeric or rubber coupling(s). The elastomeric or rubber couplings act as the dynamic couplings that distort as dynamic forces are applied to the material. The incompressibility of rubber causes the elastomeric material to distort rather than merely compress under loads. This provides the damping action.

The elastomeric couplings may optionally be arranged around the circumference of the damping mass. Thus, cutting forces acting in complex multi-directions can be damped.

The damping mass may be in the form of a generally cylindrical body with two opposing end faces and one or more elastomeric couplings arranged on the end faces of the damping mass. According to such an arrangement a simple and reliable construction of tooling damper can be realised which is simple to manufacture and also minimises complex modelling to select the damping mass and required elastomeric reaction forces. Radial and axial cutting forces as well as complex cutting forces can thus be damped.

In one arrangement the elastomeric couplings may be in the form of O-rings. Thus, manufacturing costs can be minimised and tight tolerances that O-ring seals provide can allow for reliable damping action.

Advantageously, the elastomeric couplings may be in the form of a plurality of discrete elastomeric elements. Thus, high cutting forces can be damped using multiple elastomeric elements and/or cutting forces can be damped with minimal diameter elastomeric elements.

The elastomeric couplings may also be coupled to the inwardly facing surface of the annular body thus facing the damping mass. Such an arrangement allows the damping mass to be manufactured as a simple geometrical shape with an outer surface machined to cooperate with the inwardly facing elastomeric elements.

In an alternative arrangement the elastomeric couplings or elements may be coupled to the outer surfaces of the damping mass. The inwardly facing surfaces of the annular body may then be machined to cooperate with the outwardly facing elastomeric elements.

Furthermore, the elastomeric or rubber elements may be continuous and portions of the inwardly facing surfaces of the annular body and/or outer surfaces of the damping mass may be provided with recesses in alignment with the line of contact of the elastomeric elements and the damping mass. Thus, the elastomeric or rubber elements may be retained in position such that vibration forces or alternatively forces used during manufacture of the damper do not dislocate the elements i.e. move the elements out of their predetermined damping positions.

The damping mass itself may be in the form of a single metallic or plastic element. This provides for simple manufacture and assembly of the damping arrangement.

The inwardly facing surface of the annular body may additionally be provided with a plurality of circumferentially spaced recesses or grooves in alignment with one or more elastomeric or rubber couplings. Again, the position of the elements can thereby be ensured.

The grooves or recesses may advantageously be equally spaced around the damper. For example, 6 grooves may be equally spaced around the damper. Each groove or recess may extend between 5 and 15 degrees around the circumference of the damper and have a depth of between 0.5 and 3 mm.

In an alternative arrangement the damping mass may be formed of a plurality of discrete and independent elements contained within the internal cavity. In such an arrangement a single damping mass surrounded by elastomeric elements may be replaced with a plurality of discrete elements within the annular body.

In one arrangement the plurality of discrete and independent elements may be in the form of a plurality of metallic elements. Such elements may be, for example, selected from powder, shot peen or metallic spheres. Other materials may also be selected for each option such as plastics with a predetermined density to effect damping. In such arrangements the movement and friction between adjacent elements in the plurality of elements cause the damping action.

Viewed from another aspect, there is provided a damper for a tool comprising a cylindrical body and a central circular aperture; the cylindrical body comprising radially inwardly extending fixtures arranged to couple the damper to a portion of the tool, wherein the damper comprises a circumferentially extending cavity within the damper, the cavity comprising a movable damping mass.

Viewed from yet another aspect there is provided a cutting tool comprising a damping apparatus as described herein. According to such an aspect a damping apparatus may be fixed to the stem of a cutting tool. This fixture may be removable to allow for damped and non-damped operation and/or maintenance. For example, the damping apparatus may be coupled to a tool holder of the machine.

Viewed from yet another aspect there is provided a tool holder comprising a damping apparatus as described herein.

Viewed from another aspect there is provided a cutting tool for a machining center comprising an elongate cylindrical body and a damping apparatus as described herein.

Viewed from another aspect there is provided a method of damping a tool stem comprising the steps of:
(A) identifying one or more positions and directions of resonant vibration at a frequency approximately equal to a cutting frequency for a machining operation; and
(B) positioning a damping arrangement as claimed in any of claims 1 to 15 to the tool holder or tool stem of the machine at the identified position and direction.

It will be recognised that the damping arrangement and tools comprising such a damping arrangement provide a reliable and highly tuneable damper which may be easily manufactured and which required minimal maintenance. Such advantages are highly desirable in manufacturing applications which extremely tight tolerances are required at high machining outputs. One such example is an aerospace engine or hybrid fuel powered component manufacturing. The rotational speeds within such application make higher tolerances and reliability highly desirable.

### BRIEF SUMMARY OF THE DRAWINGS

Aspects of the disclosure will now be described, by way of example only, with reference to the accompanying figures in which:

FIG. 1 shows a schematic of the main components of a computer numerically controlled (CNC) milling station or machine;

FIG. 2 shows a spindle of such a milling machine of the type one embodiment described herein may be applied to;

FIG. 3 shows the main components of a damping arrangement described herein before assembly;

FIG. 4 shows a side view of a milling machine spindle, tool holder, tool and also the damping arrangement described herein;

FIGS. 5 and 5A show a view of the tool with a damping collar described herein;

FIG. 6 shows the annular body (or tool collar) of a damping arrangement described herein;

FIG. 7 shows a cross-section through a damping arrangement described herein;

FIG. 8 shows a cross-section through a solid damping mass arrangement;

FIGS. 9A and 9B show a recessed arrangement around a damper annular body;

FIGS. 10A and 10B show an alternative arrangement of elastic coupling;

FIGS. 11A and 11B show an alternative embodiment of a damping mass;

FIGS. 12A, 12B and 12C show different arrangements of particulate elements which may be selected for the damping mass;

FIGS. 13A, 13B and 13C show alternative positioning of a damping arrangement described herein; and

FIG. 14 shows alternative positioning of a damping arrangement with respect to a tool beam or stem.

Any reference to prior art documents in this specification is not to be considered an admission that such prior art is widely known or forms part of the common general knowledge in the field. As used in this specification, the words “comprises”, “comprising”, and similar words, are not to be interpreted in an exclusive or exhaustive sense. In other words, they are intended to mean “including, but not limited to”. The invention is further described with reference to the following examples. It will be appreciated that the invention as claimed is not intended to be limited in any way by these examples. It will also be recognised that the invention covers not only individual embodiments but also combination of the embodiments described herein.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the spirit and scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

### DETAILED DESCRIPTION

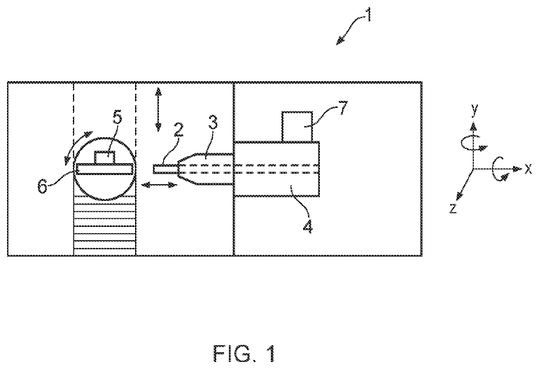

FIG. 1 is a schematic of a typical multi-axis machining center 1. The example shown is a milling machine comprising a cutting tool 2 coupled to a spindle 3. The spindle 3 incorporates a tool holder which holds the cutting tool at one end and provides a connection for coupling the tool holder and cutting tool to the spindle 3.

The spindle is coupled to a spindle drive arrangement 4, which is arranged to rotate the spindle (and thus the tool) at high speed. At the opposing end of the machining center (to the drive arrangement) is the chamber that houses the component to be machined (the workpiece) 5 which is secured to a movable table 6. The table 6 is movable in multiple directions (vertically and rotationally). In combination with the axial movement of the cutting spindle the cutting tool can be moved relative to the workpiece in each of the axes shown to the right of FIG. 1.

The machining center comprises a large number of sensors which accurately detect the position of the table 6 and cutting tool so that in operation accurate machining can be performed.

The table 6, spindle 3 and drive arrangement 4 each have a large mass to prevent excessive vibrations during a machining operation. Increasing the mass and rigidity of each of the components of the machining center reduces vibrations during machining, allowing for accurate machining. A vibration alarm 7 is however provided which deactivates the cutting (milling) operation if vibration levels exceed a predetermined threshold. In this scenario a vibration or ‘excessive movement’ alarm is used which detects machine vibration and compares it to a predetermined threshold or level. Vibrations may increase beyond a predetermined level for a number of reasons such as increased tool wear, an increased hardness in a portion of the workpiece or unfavorable cutting characteristics/conditions.

The inventors have however devised an alternative arrangement to effectively damp the vibrations directly on the tool holder or tool beam as described below.

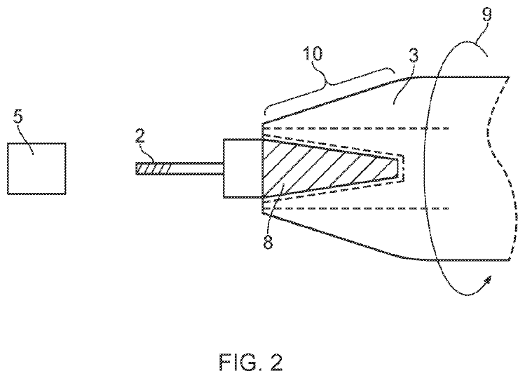

FIG. 2 shows a simple cross-section through a conventional machine showing the spindle 3, cutting tool 2 and workpiece 5. The cutting tool 2 is connected to the spindle 3 by means of a tapered tool holder 8 which allows cutting tools to be conveniently changed within the spindle 3. During operation of the machine (manufactured by Grobe in this example) the spindle 3, tool holder 8 and tool 2 may be caused to rotate at speeds of anywhere between 100 rpm and 16,000 rpm as shown by the arrow 9. Higher speeds are also possible. For example, when machining Aluminium speeds of up to 30,000 may be used.

All tools have a number of natural frequencies in their basic construction. Some of these natural frequencies can be disruptive and lead to excessive vibrations during a machining operation. The natural frequencies originate from each part or element in the tool. The different vibrations interact (both constructively and destructively) resulting in an overall vibrational performance of a tool being complex and specific to the given machine and, importantly, operating or cutting speeds and conditions.

In one example, there is a need to improve the dynamic stability of a cutting tool at a given cutting speed in revolutions per minute (rpm). For example, for a ceramic cutting tip this may be a cutting speed of 12,000 rpm and a frequency of 200 Hz.

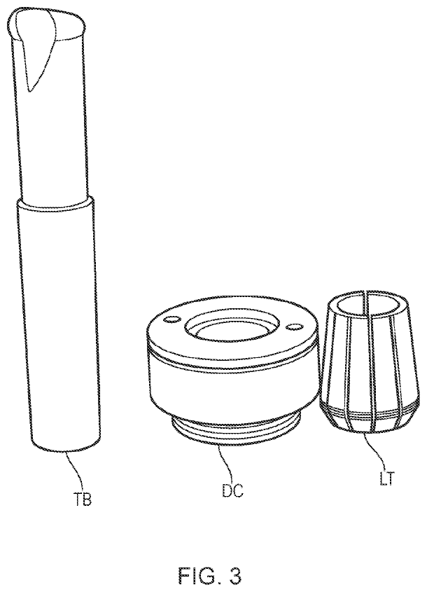

FIG. 3 illustrates the principal components of the damping arrangement described herein.

The arrangement comprises a tool beam (TB) that carries a ceramic tool (or the like) in a conventional distal cutting bit connector. The tool beam is located within the damping collar (DC) shown in the center of FIG. 3. The damping collar contains the damping arrangement described below within the cylindrical body. The tool beam in the example shown is used for milling operations.

It will be recognised that the arrangements conveniently allows the damper to be positioned at any point along the tool beam shaft, either abutting with the tool holder on the right or towards the distal end of the tool beam (towards the left).

The collar is located around the tool beam and is then tightened causing the collar to grasp the outer surface of the tool beam. The damper can then be secured to the tool beam at the desired position.

As will be described below, the unconventional damping arrangement and effect are achieved entirely within the damping collar DC meaning conventional tool beams and couplings to cutting machines can be used. Thus, a damper described herein can be conveniently retro-fitted to existing tool beams or tool holders for effective damping. If fact, the arrangement described herein can be adapted to fit onto any tool beam or tool holder to achieve a damping effect.

During operation of the machining apparatus vibrations are created in the machine and tool and this causes vibration of the outer casing of the damping collar. This in turn causes vibration of the damping mass through the elastomeric O-ring connections and this creates a damping effect because of the latency of movement of the damping mass with respect to the damping unit as the elastomeric couplings compress and expand out of synchronisation with the excitation frequency.

The specific performance of the damper can be selected depending on the characteristics of the machine and the desired damping performance. For example, the contact area between the damping mass and annular body (described below) may be modified in combination with the elastomer hardness to achieve the desired performance. In one example, a shore hardness of between 70 and 90 shore A may be used.

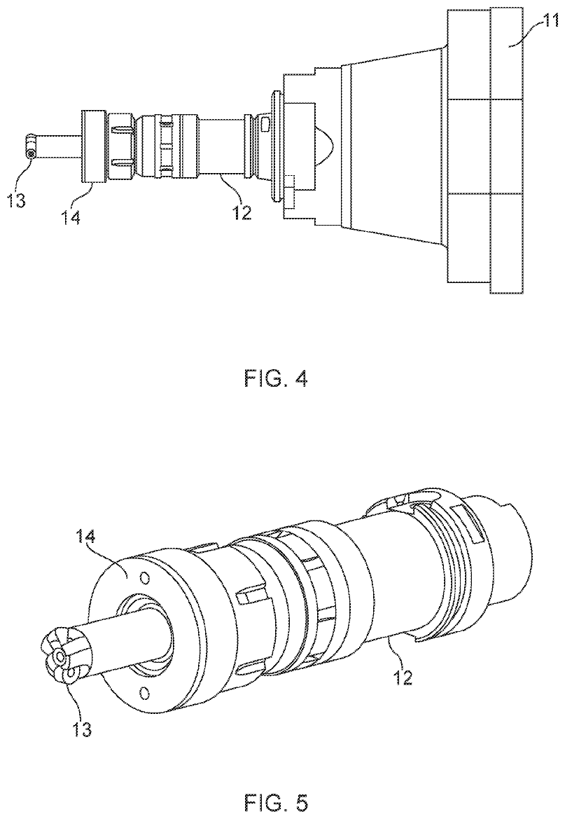

FIG. 4 shows a side view of a tool holder (12) and tool stem according to the disclosure. A milling machine tool head 11 is shown in this example.

The arrangement comprises a tool holder (12) which holds and supports a cutting tool 13. The cutting tool itself holds a cutting tip which engages and cuts the workpiece during the milling operation.

According to the disclosure, an annular damping arrangement 14 is provided. In the example shown in FIG. 4 the damper is coupled to the tool stem but it may be coupled to the tool holder as described below.

The damper (the damping collar illustrated in FIG. 3) is arranged to encircle the tool stem (or tool holder) and is in the form of an annular body. This is shown in FIGS. 5 and 5A.

The damper 14 is shown in FIGS. 5 and 5A and is arranged circumferentially around the cutting tool 13. FIG. 5 corresponds to FIG. 5A but at a slightly different angle illustrating the damper and tooling. The damper is arranged to slide over the end of the tool 13 and to abut with the outer surface of the tool stem body. This may be by interference fit or by means of a suitable coupling such as radially inwardly extending screws such as grub screws or the like. The damper is thereby mechanically coupled to the tool stem or to the tool holder body in another example. Thus, rotation of the milling tool causes a corresponding rotation of the damper.

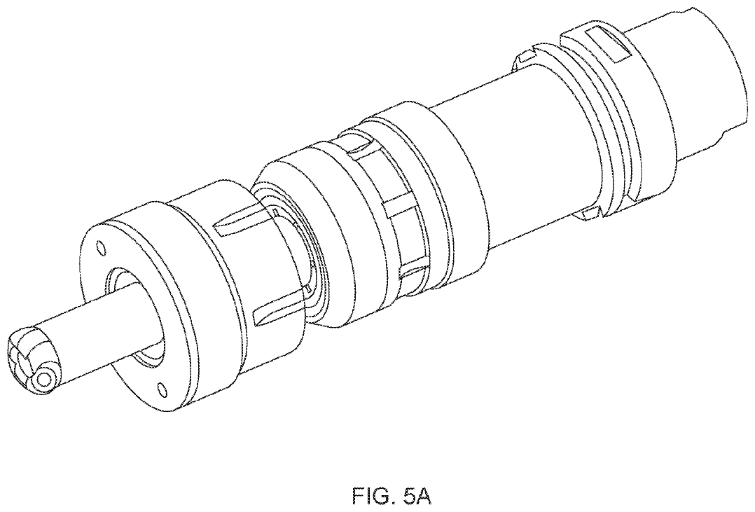

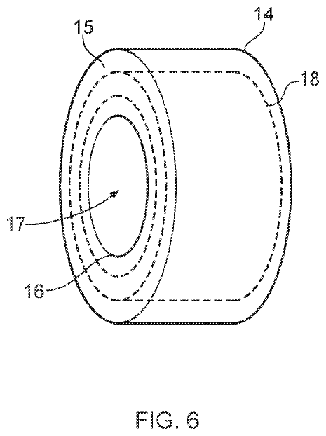

FIG. 6 shows a damper 14 in isolation. As shown the damper 14 comprises an annular body 15 and an inner aperture 16 passing through the center of the damper. The aperture is sized to accommodate either the tool stem/beam or the tool holder according to the application. More specifically the aperture is sized to accommodate the collar coupling arrangement shown in FIG. 3 which secures the damper to the tool beam. The aperture 16 comprises an inner surface 17 which is brought into contact with the outer surface of the securing collar.

FIG. 6 also illustrates the internal cavity 18 which is shown by the dashed lines within the body of the annular body 15. In the example shown the cavity is in the form of a continuous circumferentially extending cavity around the annular body. In another example the cavity may be sub-divided into a plurality of separate cavities collectively forming an annularly arranged cavity.

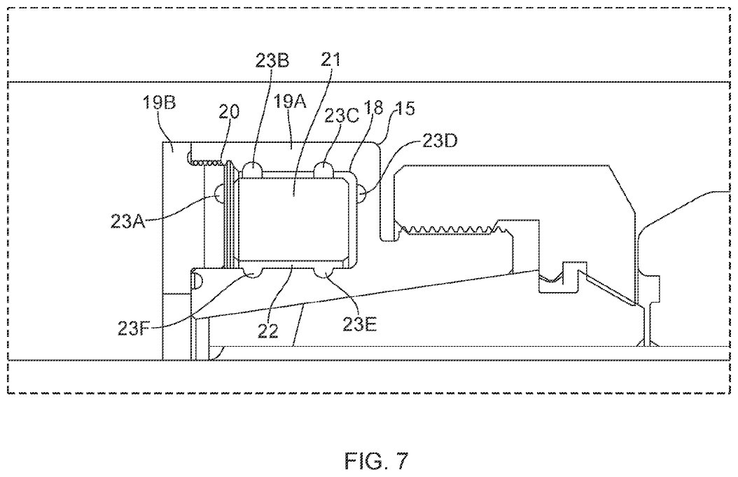

FIG. 7 shows a cross-section through a cavity according to an embodiment.

The annular body 15 comprises an internal cavity 18. The body 15 is formed of a first portion 19A in which the cavity 18 is formed and a second portion 19B which forms the closed end of the cavity 18. The two portions 19A and 19B are coupled together with a threaded portion 20. This allows the cavity to be closed.

The cavity 18 comprises a damping mass 21 which is contained within the cavity 18. As shown the damping mass 21 is spaced from the inner surface of the cavity by a space 22.

The damping mass 21 is separated from, and connected, to the inner surface of the cavity 18 by a plurality of elastic couplings 23A-23F. The elastic couplings are arranged to allow movement of the damping mass relative to the inner surfaces of the cavity. The elastic properties of the elastic couplings cause a latency in movement of the damping mass relative to the cavity surfaces. This latency provides a damping effect.

In the arrangement shown in FIG. 7 the elastomeric couplings are in the form of a series of O ring seals which are positioned around the radial surfaces of the damping mass and around the axial surfaces of the damping mass (axial with respect to the axis of the tool/tool holder).

In use vibration of the tool/tool holder is transmitted to the annular body and, through the elastic couplings, to the damping mass. Because the elastic couplings impart a latency to the movement of the damping mass relative to the annular body a damping effect is achieved which acts to damp the vibration of the annular body and thereby the tool or tool holder to which the annular body is attached.

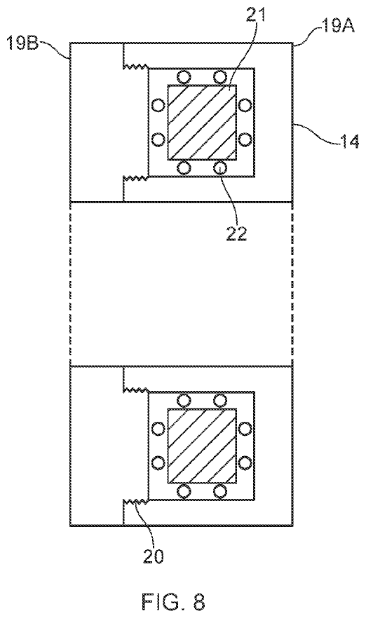

FIG. 8 shows a cross-section through one embodiment of the damper. The annular body 15 comprises the cavity which itself contains the damping mass 21. In the embodiment shown in FIG. 8 the damping mass is a solid metallic ring which is spaced from the annular cavity by the plurality of elastomeric O-ring seals 22 arranged radially and axially with respect to the damping mass 21. In other arrangements it may be a plastic or other suitable material.

The O-ring seals provide the elastic coupling between the damping mass and the annular body. This provides for the relative movement of the damping mass with respect to the annular body and thus the damping effect can be realised. The cross-section shown in FIG. 8 illustrates the general construction of the annular damping body comprising portion 19A (which forms the cavity) and portion 19B which closes the end of the cavity and is coupled to the portion 19A by the threads 20.

The elastomeric elements, such as the O-rings, may be arranged to be in continuous contact with the damping mass 21 on one side and the inner surface of the cavity on an opposing surface. In such an arrangement the O-ring seals may extend continuously around the circumference of the damping mass and in circular profiles around the axial ends of the damping mass. The damping mass is thereby spaced from the surrounding cavity inner wall but is simultaneously coupled thereto through the elastomer material.

An alternative arrangement is shown in FIGS. 9A and 9B. Here the O-ring seal 22 extends around the damping mass in a circumferential arrangement. Recesses 23 are arranged on the inner surface of the damping mass and are spaced around the periphery of its circumference, as shown in FIG. 9A. Each recess has a depth Δt. This recess reduces the compression of the O-ring seal which allows the damping effect to be accurately selected. The dynamic performance of the damper can also be tuned i.e. the speed with which damping occurs.

It will be recognised that the recesses could equally be additionally or alternatively formed on the outer surface of the damping mass itself in another example embodiment.

By selecting the hardness of the O-ring material and the size of the recess a pre-loading or compressive force can be created on the O-ring. In effect the optimum attenuation for a given modal mass can be achieved by selecting the appropriate hardness. The selected hardness will be dependent on the vibration and damping mass and the desired attenuation.

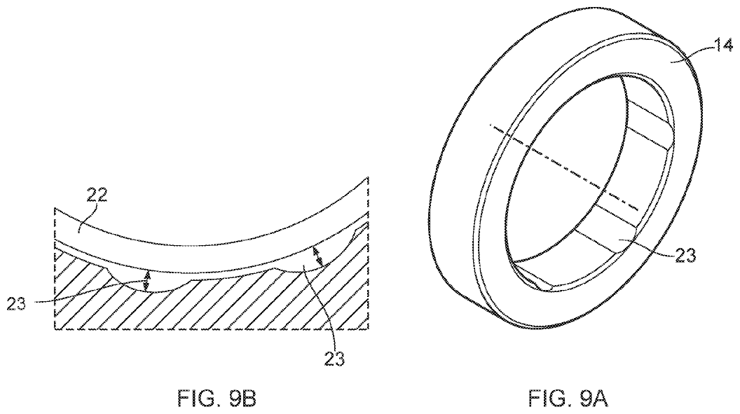

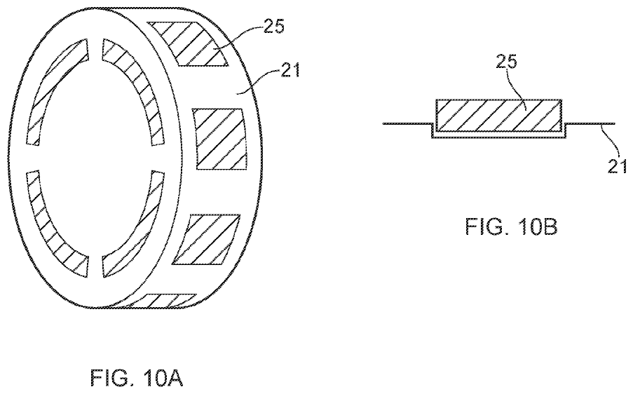

FIGS. 10A and 10B illustrate an alternative arrangement of the elastomeric spacer instead of an O-ring seal arrangement. Here, a plurality of elastomeric portions 25 are located around the perimeter of the damping mass 21. The effect is the same as that described above with respect to the use of O-ring seals. It will be recognised that the elastomeric portions 25 may equally be arranged on the inner surface of the 21. Such an arrangement negates the need for the recesses shown in FIGS. 9A and 9B owing to the discrete nature and spacing of the elastomeric portions 25.

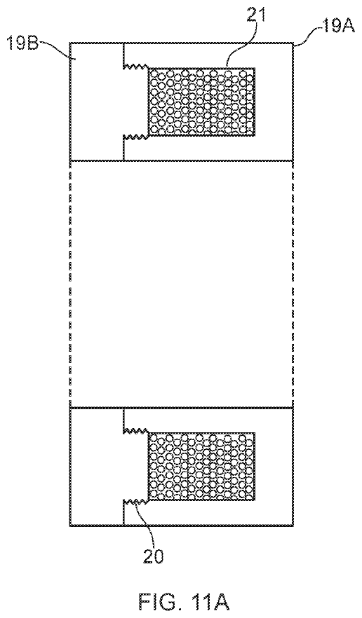

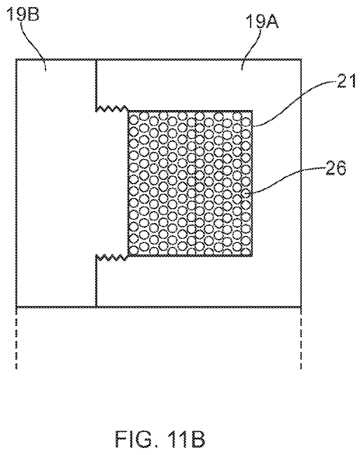

FIGS. 11A and 11B show a still further embodiment. In the example shown in FIGS. 11A and 11B the damping mass is formed of a plurality of discrete elements 26 (shown in FIG. 11B) contained within the cavity formed in the annular body. The elements 26 may be any suitable dense material which collectively form the damping mass of the damper. Advantageously, using a plurality of discrete elements which are contained within the cavity but free to move, enhances the damping effect over a single, homogenous metallic damping mass (or other suitably dense material). The damping effect of such an arrangement as shown in FIGS. 11A and 11B is enhanced because of the friction between immediately adjacent elements 26. Friction, caused by contact between adjacent elements 26, acts to enhance the damping effect within the damper. In effect the friction and movement of the elements within the cavity provides the same effect as the single homogeneous mass and elastomeric connection to the inner surface of the cavity.

The arrangement shown in FIGS. 11A and 11B provides a simpler construction of damper since use of the individual elements 26 negates the need for O-ring seals and associated recesses to locate them. It is also convenient to manufacture.

The elements 26 may be selected according to the desired damping requirements. The number and density of the elements may be selected to achieve a desired cumulative mass of the damping mass. In one arrangement a shot peen material may be used comprising individual elements having a size of approximately 0.30 mm in diameter (ranging between 0.2 mm and 0.4 mm). In one arrangement the diameter is 0.36 mm.

In another arrangement a metal, plastic or textile may be selected. The size may advantageously be between 0.3 mm and 15 mm in diameter and have a density of between 0.5 and 19 kg/dm³

FIG. 11B shows an enlarged cross-section through a damping mass utilising discrete elements 26.

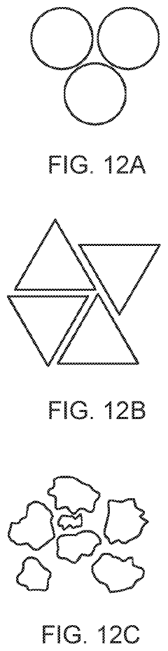

FIGS. 12A, 12B and 12C illustrate alternative options for the particular or discrete damping mass as shown in FIGS. 11A and 11B. FIG. 12A illustrates a spherical arrangement of damping mass particles. FIG. 12B illustrates a triangular tessellating arrangement and FIG. 12C a powder composition of damping mass. Each may be conveniently placed or poured into the cavity defined within the annular body.

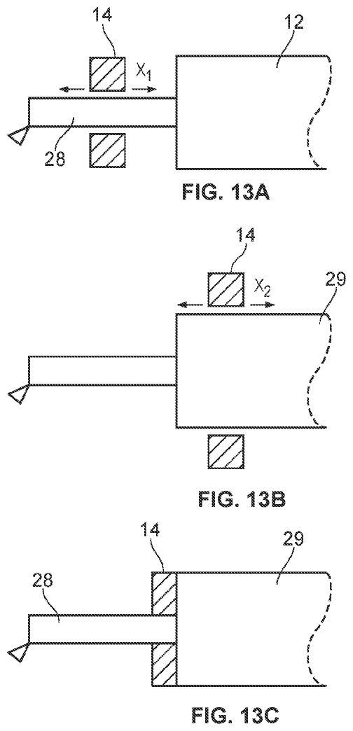

FIGS. 13A, 13B and 13C illustrate the positioning options of a damping arrangement as described herein.

In FIG. 13A the damping arrangement is located around the tool stem (also called a tool beam). In effect damping is achieved from outside i.e. surrounding the tool beam. This arrangement may be used where the tool stem is long and provides space to locate the damping arrangement on the tool stem itself. The damping annular body 14 (the tool collar or collet shown in FIG. 3) may be coupled to the tool stem in a variety of ways, for example using a pair of collars on each side of the body 15 or by fixing the damping annular body to the stem using suitable screws or fixings. The damping body 14 may be moved along the x1 direction along the stem so as to be positioned at the point of greatest vibration of the tool. This can be determined using techniques known to a person skilled in the art such as those described above. When affixed to the tool holder a screw arrangement may be used. When located at a position along the tool beam and collar/collet arrangement may be used using tapered members as shown in FIG. 3.

FIG. 13B shows an alternative arrangement in which the damping annular body is coupled to the tool holder 29. This arrangement may be used where the tool stem is short. As above the damping annular body 14 may be coupled to the tool holder in a variety of ways, for example using a pair of collars on each side of the body 14 or by fixing the damping annular body to the holder using suitable screws or fixings. The damping body 14 may be moved along the x2 direction along the tool holder so as to be positioned at the point of greatest vibration of the tool.

Finally, FIG. 13C shows an arrangement where the annular body 14 is arranged immediately adjacent and connected to the tool holder and surrounds the tool stem 28.

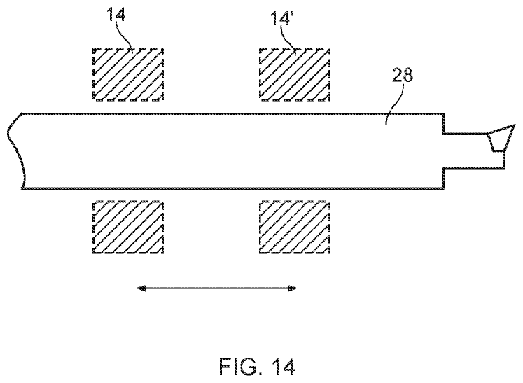

FIG. 14 illustrates relative positions of the damper annular body 15 along the tool stem or beam. The position of the body may be adjusted between different positions 14, 14′ depending on parameters such as cutting speed, available space and so forth and determined using techniques described above.

1.-22. (canceled)

23. A damping apparatus for a machine tool, comprising:
an annular body with an inwardly facing surface, the inwardly facing surface arranged for coupling to an outer surface of a machine tool stem or an outer surface of a machine tool holder, wherein the annular body comprises an internal cavity, the cavity comprising a damping mass.

24. A damping apparatus as claimed in claim 23, wherein the damping mass is coupled to and spaced from an inwardly facing surface of the internal cavity by one or more elastomeric or rubber couplings.

25. A damping apparatus as claimed in claim 24, wherein the elastomeric couplings are arranged around the circumference of the damping mass.

26. A damping apparatus as claimed in claim 24, wherein the damping mass is in the form of a generally cylindrical body with two opposing end faces and one or more elastomeric couplings are arranged on the end faces of the damping mass.

27. A damping apparatus as claimed in claim 24, wherein the elastomeric couplings are in the form of O-rings.

28. A damping apparatus as claimed in claim 24, wherein the elastomeric couplings are in the form of a plurality of discrete elastomeric elements.

29. A damping apparatus as claimed in claim 24, wherein the elastomeric couplings are coupled to the inwardly facing surface of the annular body.

30. A damping apparatus as claimed in claim 24, wherein the elastomeric couplings are coupled to the outer surfaces of the damping mass.

31. A damping apparatus as claimed in claim 24, wherein the elastomeric or rubber couplings are continuous and portions of the inwardly facing surface of the internal cavity and/or an outer surface of the damping mass are provided with recesses in alignment with a line of contact of the elastomeric couplings and the damping mass.

32. A damping apparatus as claimed in claim 23, wherein the damping mass is in the form of a single metallic or plastic element.

33. A damping apparatus as claimed in claim 24, wherein the inwardly facing surface of the internal cavity is provided with a plurality of circumferentially spaced recesses in alignment with the one or more elastomeric or rubber couplings.

34. A damping apparatus as claimed in claim 33, wherein the recesses have an angle of between 5 and 15 degrees measured circumferentially around the apparatus and a depth of between 0.5 mm and 3 mm.

35. A damping apparatus as claimed in claim 23, wherein the damping mass is formed of a plurality of discrete and independent elements contained within the internal cavity.

36. A damping apparatus as claimed in claim 35, wherein the plurality of discrete and independent elements are a plurality of metallic elements.

37. A damping apparatus as claimed in claim 36, wherein the metallic elements are selected from powder, shot peen or metallic spheres.

38. A damper for a tool comprising a cylindrical body and a central circular aperture; the cylindrical body comprising radially inwardly extending fixtures arranged to couple the damper to a portion of the tool, wherein the damper comprises a circumferentially extending cavity within the damper, the cavity comprising a movable damping mass.

39. A cutting tool comprising:
a damping apparatus for a machine tool, including an annular body with an inwardly facing surface, the inwardly facing surface arranged for coupling to an outer surface of a machine tool stem or an outer surface of a machine tool holder, wherein the annular body comprises an internal cavity, the cavity comprising a damping mass.

40. A cutting tool as claimed in claim 39, wherein the damping apparatus is fixed to the stem of the cutting tool.

41. A cutting tool as claimed in claim 39, wherein the damping apparatus is coupled to a tool holder of the machine.
